(19) United States
(12) Patent Application Publication
(10) Pub. No.: US 2014/0007764 A1
(43) Pub. Date: Jan. 9, 2014

(54) TEXTILE ACTIVATOR

(71) Applicant: Jörg Ruschulte, Rickenbach (DE)

(72) Inventor: Jörg Ruschulte, Rickenbach (DE)

(73) Assignee: GLOBAL SAFETY TEXTILES GMBH, Maulburg (DE)

(21) Appl. No.: 14/006,370

(22) PCT Filed: Mar. 21, 2012
(86) PCT No.: PCT/EP12/01235

§ 371 Date: Sep. 20, 2013

(30) Foreign Application Priority Data
Mar. 22, 2011 (DE) 10 2011 014 678.8

(51) Int. Cl. F15B 15/10

(52) U.S. Cl. CPC F15B 15/10
USPC 92/96

(57) ABSTRACT

The invention relates to an actuating device with at least one textile airbag that has at least two textile fabric layers that lie one over the other, said airbag comprising a first fillable chamber of a first size, wherein the chamber can be brought from a non-filled or only slightly filled inoperative state into a filled actuated state by filling with a fluid. The airbag has anchoring points on which said airbag can be connected to objects to be actuated.

The present invention relates to an actuator.

Mechanical and pneumatic actuators are known which are employed in mainly automated systems also in making use of robotic devices, e.g. for manipulating objects.

Linear movements are provided, for example, to move an object from a position A to a position B. Achieving this necessitates complicated drives, constructions or controllers which directly—e.g. via rotary connectors or magnetic fields—or indirectly, e.g. hydraulically or chains or pneumatic cylinders making the movement possible.

The invention is based on the object of proposing a device with which the drawbacks known from prior art are now avoided or at least greatly diminished.

This object is achieved by an actuator as set forth in claim 1, namely an actuator characterized by at least one textile airbag comprising at least two superimposed layers of fabric with a first inflatable chamber of a first size which by being inflated with a fluid can be activated from a deactivated posture empty or only partly inflated into an activated filled posture, wherein the airbag comprises anchoring points by which it can be connected to the objects to be actuated. Due to the configuration of the actuator in accordance with the invention it can be put to use to advantage as a low-cost actuator for traction actions variously dimensioned as a function of the chamber diameter and substantially linear, for example. Thus, e.g. cylindrical, tubular or spherical chambers comprise cross-sectionally, due to their correspondingly composed encasing faces, an equatorial length, the diameter of which is smaller than the double-folded encasing face when laid out flat or equatorial length. Derived from the ratio of the diameter of the chamber cross-section to its circumference the diameter is approx 36.3% smaller than the double-folded encasing face when laid out flat. When traction members are secured e.g. to, as such, opposing positions of joints (seams) of a cylindrical chamber, a linear traction movement can be implemented, wherein the flat double layer, considered as a closed body, translates into a practically circular configuration, e.g. when inflating the chamber with compressed air.

In one advantageous embodiment of the invention the two textile fabric layers are stitched with a seam encircling the chamber. This advantageous embodiment results in production of a stable customized design of the airbag.

In another advantageous embodiment of the invention the two textile fabric layers are interwoven in one piece as an OPW (one-piece-woven) fabric, wherein the seam constitutes as a woven seam a single-layer portion connecting the two textile fabric layers. This to advantage, represents an even more favourable variant in accordance with the invention as proposed above in which the OPW technology allows for every finesse in the wanted design of the chamber, and now highly cost-effective.

In another advantageous embodiment of the invention the actuator comprises a number of chambers each spaced apart from the other, making a further degree of freedom in selecting the design, whereby the extents of the traction movements can be individually multiplied.

In yet another advantageous embodiment the chamber(s) of the airbag comprise in their interior tethers or spacers secured to anchoring points of the two textile fabric layers in being suitable to influence, especially to definedly restrict, the shape of the airbags when inflated.

Further advantages of the device in accordance with the invention are shown in the following. How much movement is achieved results from how the chambers are designed in size and arrangement and can also be calculated as regards the space available.

Furthermore, by means of dimensioning the chambers in conjunction with the pressure of the inflow of fluid configuring the chambers on being charged with increasing volume, the initially high traction force and the traction force becoming reduced towards the end of the traction movements down to the holding force can all be predetermined.

By an in-line array of a number of inflatable or chargeable, respectively, chambers the extent for movement as a whole can be enlarged and adjusted. By arranging the chambers the same and/or differing in size and inflating them with fluid each independent of the other, separately or in common in-line diverse positions can be definedly activated linearly.

When a number of chambers are arranged juxtaposed in parallel the traction can be set individually.

When a number of chambers to be inflated differ in stretch and shaping, the surface can be additionally altered in appearance.

The chambers to be configured can be produced in OPW technology. Since shaping is individually very finely adjustable in the weave technically a simple cost-effective method of production is now available. The chambers can be of any shape geometrically, particularly cylindrical, conical or round. In conjunction with an applied coating air-tightness is assured, permitting no problem in inflating the system.

Furthermore, shaping is now also possible in conjunction with any jointing techniques whatsoever, such as e.g. stitching, adhesive bonding, welding. Here too, all geometric shapes are feasible. Where necessary, additionally sealing connection locations is an advantage.

Further advantageous embodiments and features of the invention read from the subclaims and the following description with reference to the drawing.

For a better understanding of the invention in showing how it can be performed this will now be briefly described in the following with the assistance of a drawing in which:

FIG. 1 is a diagrammatic view showing the ratio of the longitudinal extension L or D of a two-layer inflatable actuator in accordance with the invention in the non-inflated condition (L) and in the inflated condition (D).

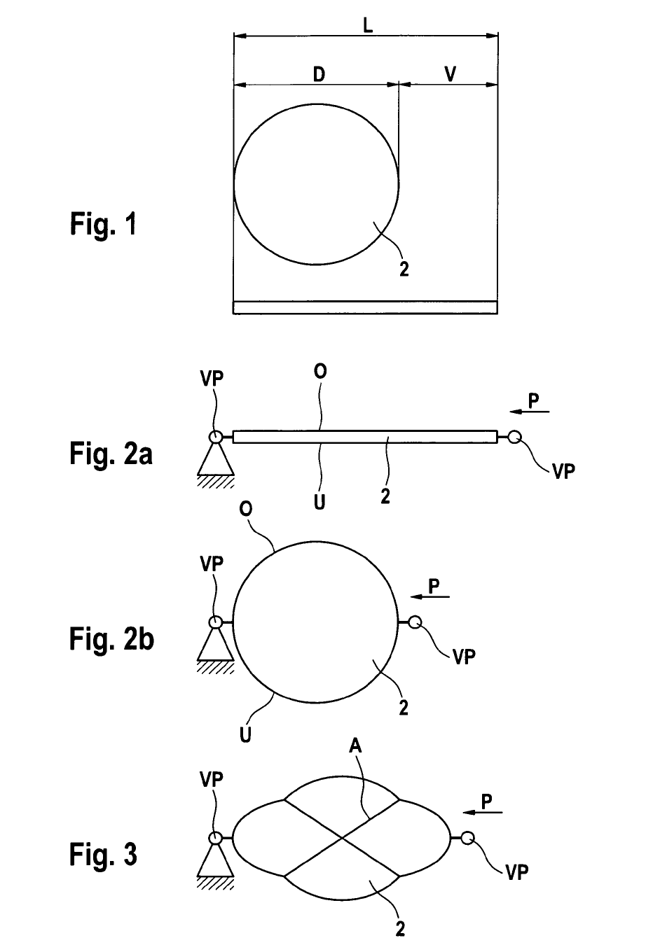

FIG. 2a is a diagrammatic view showing a two-layer inflatable actuator (actuating device) in the non-inflated condition or non-charged condition.

FIG. 2b is a diagrammatic view showing the actuator (actuating device) as shown in 2a in the inflated condition or charged condition.

FIG. 3 is a diagrammatic view showing the cross-section of a basically cylindrical chamber of an actuator in accordance with the invention featuring inwoven tethers.

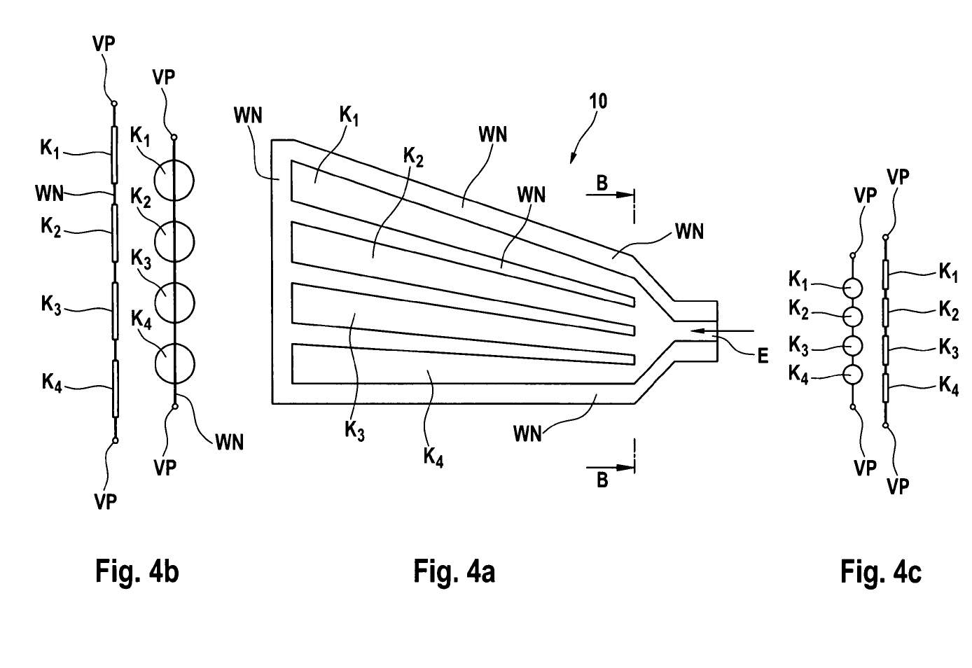

FIG. 4a is a diagrammatic view showing in a top-down view an airbag featuring an array of chambers of with changing diameters.

FIG. 4b is a diagrammatic view showing the airbag as shown in FIG. 4a as seen from the left in the non-inflated condition and in the inflated condition.

FIG. 4c is a diagrammatic view showing the airbag as shown in FIG. 4a as seen from the right in the section B-B in the non-inflated condition and in the inflated condition.

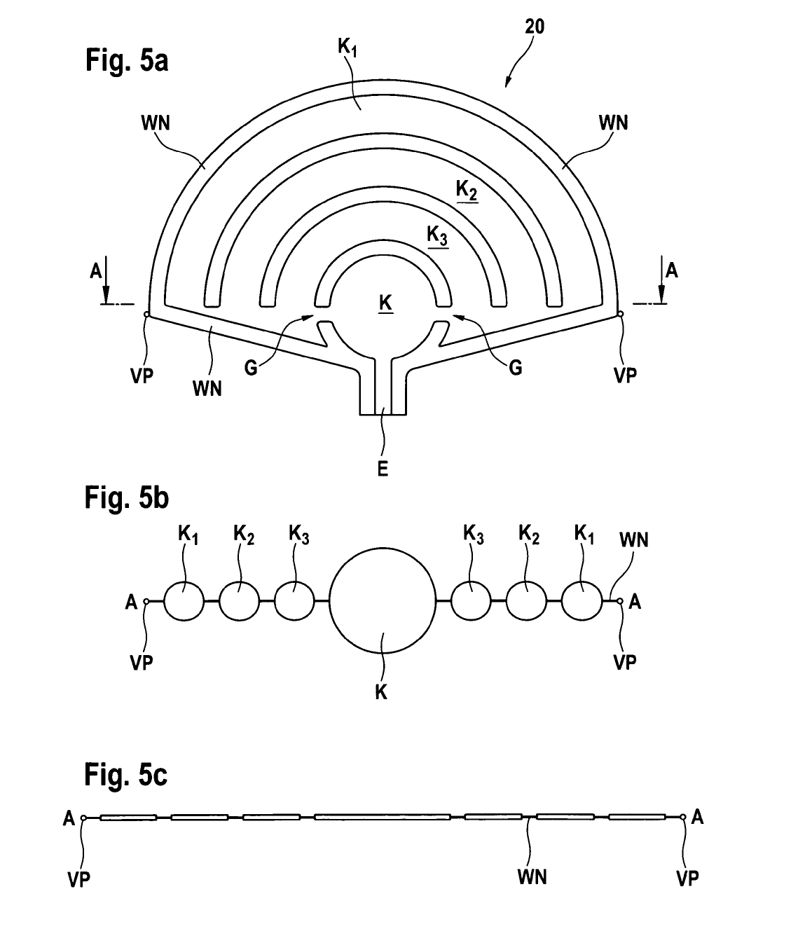

FIG. 5a is a diagrammatic view showing a further shape of an actuator in accordance with the invention in a top-down view.

FIG. 5B is a diagrammatic view showing the airbag as shown in FIG. 5a in a bottom-up view in section A-A in the inflated condition.

FIG. 5C is a diagrammatic view showing the airbag as shown in FIG. 5a in a bottom-up view in section A-A in the non-inflated condition.

Referring now to FIGS. 1, 2a and 2b there is illustrated the principle of how an actuator in accordance with the invention functions in which L represents the “stretched” length of the two textile layers of fabric O, U of the actuator. The traction materializes from the shortening by 36.3% of the non-inflated length “L” by the non-inflated chamber being rendered “three-dimensional” by the pressure. Inflation of the chamber 2 causes an object (not shown) to be actuated to move over the distance V in the direction of an arrow P.

Referring now to FIG. 3 there is illustrated the cross-section of an airbag featuring an, in principle, cylindrical or spherical chamber 2 without any tether, but here in this case with inwoven tethers A, resulting in a redimensioned inflated height of the chamber 2 as well as a shortened traction in the direction of the arrow P (e.g. 36.3% shortening without any tether, e.g. 12.5% with tether) Using the OPW “spacer” or “tether” as a design member now makes it possible to advantage to achieve a substantially lesser shortening of the traction for an insignificantly lesser (9.75%) inflation height which here in this case is reduced underproportionally e.g. by just 9.75%—as measured at the diameter—of the chamber having no tether.

The air intake on inflation or pressurization is guided either by integrated components, as shown in FIGS. 4a and 5a for example, or separate for each component or chamber as shown in FIG. 2b. The maximum shortening V per chamber is always max 36.3% of L.

Referring now to FIGS. 4a to 4c and 5a to 5c there is illustrated the array of chambers differing in diameter and how they are arranged in the textile component each relative to the other as spaced by woven seams. Shortening the device by pressure is dictated by the design, e.g. fan or circular shaped.

Referring now to FIG. 4a there is illustrated in a diagrammatic top-down view an airbag 10 with an array of chambers K1 to K4 having changing diameters between each of which the woven seam WN is evident. The diameter of the chambers K1 to K4 is tapered as shown in FIG. 4a from left to right. When deployed the airbag 10 is inflated via the inflator port E on the right-hand side to expand “three dimensional”. In doing so, the airbag 10 changes shape from that as shown in FIG. 4b on the left-hand side into the shape as shown in FIG. 4b on the right-hand side. Analogous to this is the change shown in FIG. 4a on the right-hand side of the airbag 10 on inflation when the cross-section along the line B-B as shown in FIG. 4a changes the shape from as shown on the right in FIG. 4c (deflated) into the shape as shown on the left (inflated).

Referring now to FIG. 5a there is illustrated diagrammatically a further embodiment of an actuator in accordance with the invention shown in a top-down view. An airbag 20 produced preferably in OPW technology features a number of chambers K1 to K3 half-encircling a central chamber K and separated from each other by a woven seam WN or single-layer portions EB. This configuration shows the universal possibilities of varying the actuator in accordance with the invention. Via the inflator port E the airbag 20 or its chambers K to K3 are inflated via the central chamber K, by fluid flowing from the inflator E via the chamber K through channels G into the chambers K1 to K3. It is understood that the fluid may be a gas as well as a liquid. The shape of the airbag in the inflated (FIG. 5 b) and non-inflated (FIG. 5c) condition is shown by means of the section line A-A. Anchoring points VP signify the possible connection of objects (not shown) to be activated.

What is claimed is:

1. An actuator wherein at least one textile airbag comprising at least two superposed textile fabric layers with a first inflatable chamber of a first size which by being inflated with a fluid can be activated from a deactivated posture empty or only partly inflated into an activated posture, wherein the airbag comprises anchoring points by which it can be connected to the objects to be actuated.

2. The actuator as set forth in claim 1, wherein the two textile fabric layers are stitched with a seam encircling the chamber.

3. The actuator as set forth in claim 1, wherein the two textile fabric layers are interwoven in one piece as a one-piece woven fabric, wherein the seam constitutes as a woven seam a single-layer portion connecting the two textile fabric layers and surrounding the chamber.

4. The actuator as set forth in claim 1, wherein it comprises a number of chambers each separated from the other.

5. The actuator as set forth in claim 1, wherein said chamber(s) of the airbag comprise in their interior tethers or spacers secured to anchoring points of the two textile fabric layers in being suitable to influence, especially to definably restrict the shape of the airbags when inflated.
